(19) United States
(12) Patent Application Publication
(10) Pub. No.: US 2009/0183373 A1
(43) Pub. Date: Jul. 23, 2009

(54) PILL CUTTING DEVICE

(76) Inventor: Hugh P. Suhr, Port Charlotte, FL (US)

Correspondence Address: EDWARD M. LIVINGSTON, PA, 963 TRAIL TERRACE DRIVE, NAPLES, FL, 34103, US

(21) Appl. No.: 12/354,810

(22) Filed: Jan. 16, 2009

Related U.S. Application Data
(60) Provisional application No. 61/021,721, filed on Jan. 17, 2008.

(51) Int. Cl. B26B 3/00

(52) U.S. Cl. 30/124

(57) ABSTRACT

A pill cutting device (1) having a lid (4) moveably attached to a base (5) via an attachment means (6), such as pivot points (7), and a cutting blade (10) secured to the inside of the lid. A holding wall (11), which is preferably V-shaped, extends upward from the base and a slidably adjustable pill retaining means (13) having an adjusting wall (14), which is preferably V-shaped, is moveably attached to the base so that a user may slide the slidably adjustable pill retaining means forwards toward the holding wall and backwards away from the holding wall. A slot (12) extends through the top of the base a predetermined distance to allow room for the cutting blade to pass through when the lid is closed.

### CROSS REFERENCE TO RELATED APPLICATION

This application claims the benefit to U.S. Provisional Application No. 61/021,721 filed Jan. 17, 2008.

### BACKGROUND OF THE INVENTION

The present invention relates to pill cutting devices, more particularly, a pill cutting device that consistently cuts pills to a predetermined size, is safe to use, easy to use and may be adjusted to accommodate pills of various sizes.

The use of pills has been and continues to be a popular method for orally administering drugs. Many drugs cost about the same per pill regardless of the dosage contained in each pill. In fact, pills having larger dosages quite often cost less than pills having smaller dosages. As a result, patients can save as much as fifty percent buying larger pills which contain twice the dosage as a smaller pill and cutting the larger pill in half. Depending on the size of a pill and a prescribed or desired dosage, a patient may want to split the pill even further into quarters and so on.

Knowing that customers were cutting their pills, many pharmaceutical companies began providing indentations on the surfaces of pills to make them easier to cut. Traditionally, individuals would use a knife or other objects to cut pills. However, even with these indentations, it is difficult and/or unsafe to cut pills because pills are hard to hold in place while cutting. Moreover, pills usually do not split evenly when cut using a knife, thereby resulting in unequal dosages.

Although pill cutting devices have been developed in the past, most do not securely hold pills in place while cutting thereby giving inconsistent dosages and/or crushing pills rather than cleanly splitting the pills in half.

Thus, the need exists for a pill cutting device that is safe, easy to use, cleanly cuts pills to consistent sizes and is adjustable to accommodate pills of various sizes.

The relevant prior art includes the following patents/applications:

| Patent/Application Number | | |
|---|---|---|
| (U.S. unless otherwise stated) | Inventor | Issue/Pub. Date |
| 2006/0201985 | Sze | Sep. 14, 2006 |
| 2003/0084574 | Eric | May 08, 2003 |
| 6,557,945 | Eric | May 06, 2003 |
| Des. 420,140 | Noble et al. | Feb. 01, 2000 |
| Des. 419,684 | Noble et al. | Jan. 25, 2000 |
| 4,887,755 | Gibilisco | Dec. 19, 1989 |
| 4,697,344 | Leopoldi | Oct. 06, 1987 |
| 4,173,826 | Leopoldi et al. | Nov. 13, 1979 |
| 3,517,871 | Gaffney et al. | Jun. 30, 1970 |

### SUMMARY OF THE INVENTION

The primary object of the present invention is to provide a pill cutting device that consistently cuts pills to a predetermined size.

Another object of the present invention is to provide a pill cutting device that is safe to use.

A further object of the present invention is to provide a pill cutting device that is easy to use.

Another object of the present invention is to provide a pill cutting device that securely holds pills while cutting them.

An even further object of the present invention is to provide a pill cutting device that is adjustable to accommodate pills of various sizes.

The present invention fulfills the above and other objects by providing a pill cutting device having a lid moveably attached to a base via an attachment means, such as pivot points, and a cutting blade secured to the inside of the lid. A holding wall, which is preferably V-shaped, extends upward from the base and a slidably adjustable pill retaining means having an adjusting wall, which is preferably V-shaped, is moveably attached to the base so that a user may slide the slidably adjustable pill retaining means forwards toward the holding wall and backwards away from the holding wall. A pill cutting area is located on the top of the base in between the holding wall and the slidably adjustable pill retaining means. The slot extends through the holding wall and the slidably adjustable pill retaining means to allow room for the cutting blade to pass through when the lid is closed. The slot may also extend through the top of the base a predetermined distance to allow room for the cutting blade to pass through when the lid is closed.

To use the pill cutting device, a user places a pill in the pill cutting area. Next, the user slides the slidably adjustable pill retaining means against the pill thereby pressing the pill against the holding wall and securing the pill in place. Finally, the user closes the lid and the cutting blade cuts through the pill extending downward through the slot, thereby insuring a clean cut. When not in use, the lid may be closed and snapped in placed.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side plan view of a pill cutting device of the present invention in an open position;

FIG. 2 is a top view of a pill cutting device of the present invention in an open position;

FIG. 3 is a side partial cross section view a pill cutting device of the present invention in a closed position;

FIG. 4 is a top view of a pill cutting device of the present invention in an open position in which the attachment means is an axle; and

FIG. 5 is a top view of a pill cutting device of the present invention in an open position in which the attachment means is a hinge.

### DESCRIPTION OF THE PREFERRED EMBODIMENTS

For purposes of describing the preferred embodiment, the terminology used in reference to the numbered components in the drawings is as follows:
1. pill cutting device
2. proximal end
3. distal end
4. lid retaining means
5. base
6. attachment means
7. pivot points
8. hinge
9. axle
10. cutting blade
11. holding wall
12. slot
13. slidably adjustable pill
14. adjustable wall
15. adjustable base
16. tenon
17. pill storage area
18. finger grip
19. pill cutting area

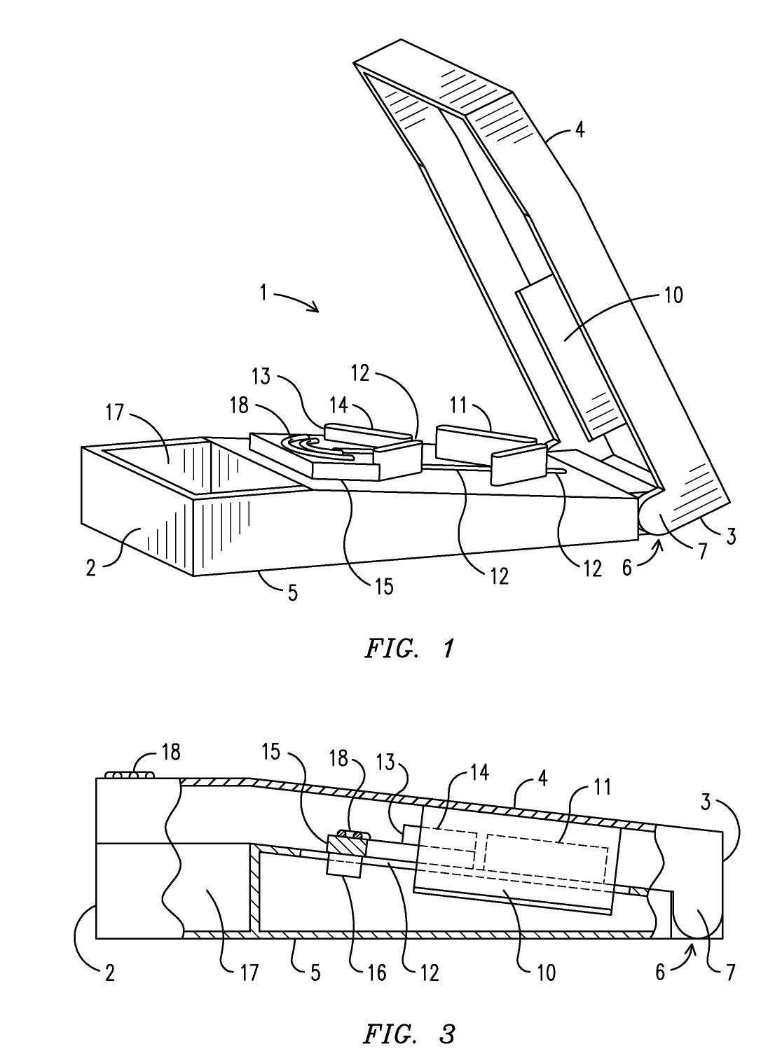

With reference to FIG. 1, a side plan view of a pill cutting device 1 of the present invention in an open position is shown. The pill cutting device 1 having a proximal end 2 and a distal end 3 includes a lid 4 moveably attached to a base 5 via an attachment means 6, such as pivot points 7, a hinge 8 and an axle 9. A cutting blade 10 for cutting pills is permanently secured to the inside of the lid 4. A holding wall 11, which is preferably V-shaped, extends upward from the base 5 at the distal end 3 of the pill cutting device 1. A slidably adjustable pill retaining means 13 having an adjusting wall 14, which is preferably V-shaped, and an adjusting base 15 is moveably attached to the base 5 so that a user may slide the slidably adjustable pill retaining means 13 forwards toward the holding wall 11 and backwards away from the holding wall 11. The slot 12 acts as a guide allowing the slidably adjustable pill retaining means 13 to slide forward and backward. A finger grip 18 may be located on the adjusting base 15 to prevent a user's fingers from sliding off the slidably adjustable pill retaining means 13. The slot 12 extends through the holding wall 11 and the slidably adjustable pill retaining means 13. The slot 12 may also extend through the top of the base 5 a predetermined distance to allow room for the cutting blade 10 to pass through when the lid 4 is closed. A pill cutting area 19 is located on the top of the base 5 in between the holding wall 11 and the slidably adjustable pill retaining means 13 to allow room for the cutting blade 10 to pass through when the lid 4 is closed. In addition, a pill storage area 17, which may be used to store pills, is located at the proximal end 2 of the base 5.

To use the pill cutting device 1, a user places a pill in the pill cutting area 19. Next, the user slides the slidably adjustable pill retaining means 13 against the pill thereby pressing the pill against the holding wall 11 and securing the pill in place. Finally, the user closes the lid 4 and the cutting blade 10 cuts through the pill extending downward through the slots 12, thereby insuring a clean cut. When not in use, the lid 4 may be closed and snapped in a closed position.

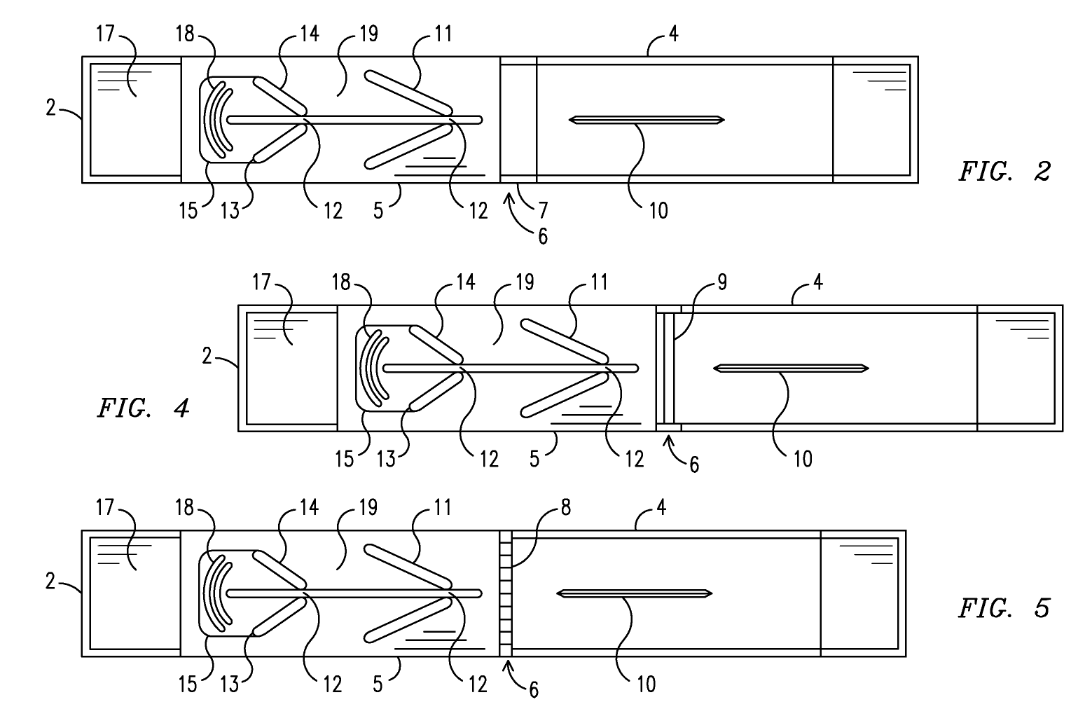

With reference to FIG. 2 a top view of a pill cutting device 1 of the present invention in an open position is shown. The pill cutting device 1 having a proximal end 2 and a distal end 3 includes a lid 4 moveably attached to a base 5 via an attachment means 6 such as pivot points 7, a hinge 8 and an axle 9. A cutting blade 10 for cutting pills is permanently secured to the inside of the lid 4. A holding wall 11, which is preferably V-shaped, extends upward from the base 5 at the distal end 3 of the pill cutting device 1. A slidably adjustable pill retaining means 13 having an adjusting wall 14, which is preferably V-shaped, and an adjusting base 15 is moveably attached to the base 5 so that a user may slide the slidably adjustable pill retaining means 13 forwards toward the holding wall 11 and backwards away from the holding wall 11. The slot 12 acts as a guide allowing the slidably adjustable pill retaining means 13 to slide forward and backward. A finger grip 18 may be located on the adjusting base 15 to prevent a user's fingers from sliding off the slidably adjustable pill retaining means 13. The slot 12 extends through the holding wall 11 and the slidably adjustable pill retaining means 13. The slot 12 may also extend through the top of the base 5 a predetermined distance to allow room for the cutting blade 10 to pass through when the lid 4 is closed. A pill cutting area 19 is located on the top of the base 5 in between the holding wall 11 and the slidably adjustable pill retaining means 13 to allow room for the cutting blade 10 to pass through when the lid 4 is closed. In addition, a pill storage area 17, which may be used to store pills, is located at the proximal end 2 of the base 5.

With reference to FIG. 3, a side plan view a pill cutting device 1 of the present invention in a closed position is shown. The pill cutting device 1 having a proximal end 2 and a distal end 3 includes a lid 4 moveably attached to a base 5 via an attachment means 6 such as pivot points 7, a hinge 8 and an axle 9. A cutting blade 10 for cutting pills is permanently secured to the inside of the lid 4. A holding wall 11, which is preferably V-shaped, extends upward from the base 5 at the distal end 3 of the pill cutting device 1. A slidably adjustable pill retaining means 13 having an adjusting wall 14, which is preferably V-shaped, and an adjusting base 15 is moveably attached to the base 5 so that a user may slide the slidably adjustable pill retaining means 13 forwards toward the holding wall 11 and backwards away from the holding wall 11. The slidably adjustable pill retaining means 13 is preferably attached to the base 5 with a tenon 16 that extends downward through a slot 12 located in the base. The slot 12 acts as a guide allowing the slidably adjustable pill retaining means 13 to slide forward and backward. A finger grip 18 may be located on the adjusting base 15 to prevent a user's fingers from sliding off the slidably adjustable pill retaining means 13. The slot 12 extends through the holding wall 11 and the slidably adjustable pill retaining means 13. The slot 12 may also extend through the top of the base 5 a predetermined distance to allow room for the cutting blade 10 to pass through when the lid 4 is closed. A pill cutting area 19 is located on the top of the base 5 in between the holding wall 11 and the slidably adjustable pill retaining means 13 to allow room for the cutting blade 10 to pass through when the lid 4 is closed. Finger grips 18 are located on the lid 4 at the proximal end 2 to prevent a user's fingers from sliding off the lid 4 while the pill cutting device 1 is in use. In addition, a pill storage area 17, which may be used to store pills, is located at the proximal end 2 of the base 5.

With reference to FIG. 4, a top view of a pill cutting device 1 of the present invention in an open position in which the attachment means is an axle is shown.

Finally in reference to FIG. 5, a top view of a pill cutting device 1 of the present invention in an open position in which the attachment means is a hinge is shown.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my inventions I claim;

1. A pill cutting device comprising:
a base;
a lid moveably attached to said base via an attachment means;
a holding wall extending upward from said base;
a slidably adjustable pill retaining means located on said base;
a slot of predetermined length extending through said holding wall and said slidably adjustable pill retaining means; and
a cutting blade fixedly attached to said lid which extends downward through said slot when the lid is in a closed position.

2. The pill cutting device of claim 1 wherein:
said holding wall is V-shaped.

3. The pill cutting device of claim 2 wherein:
said slidably adjustable pill retaining means is V-shaped.

4. The pill cutting device of claim 1 wherein:
said attachment means are pivot points.

5. The pill cutting device of claim 1 wherein:
said attachment means is a hinge,

6. The pill cutting device of claim 1 wherein:
said attachment means is an axle.

7. The pill cutting device of claim 1 wherein:
said slidably adjustable pill retaining means attaches to said base via a tenon which passes through said slot located in the base.

8. The pill cutting device of claim 1 wherein;
said slidably adjustable pill retaining means further comprises an adjustable wall and an adjustable base.

9. The pill cutting device of claim 3 wherein:
said slidably slidable adjustable pill retaining means further comprises an adjustable wall and an adjustable base.

10. The pill cutting device of claim 8 wherein:
said slidably adjustable base farther comprises finger grips.

11. The pill cutting device of claim 9 wherein:
said adjustable base further comprises finger grips.

12. The pill cutting device of claim 1 further comprising:
a pill storage are located in said base.

13. The pill cutting device of claim 1 further comprising:
finger grips located on said lid.

14. The pill cutting device of claim 9 further comprising:
finger grips located on said lid.

15. The pill cutting device of claim 1 wherein:
said slot extends a predetermined length through said base.

16. The pill cutting device of claim 3 wherein:
said slot extends a predetermined length through said base.

17. A pill cutting device comprising;
a base;
a lid moveably attached to said base via an attachment means;
a V-shaped holding wall extending upward from said base;
an V-shaped slidably adjustable pill retaining means located on said base;
a slot of predetermined length extending through said base, said holding wall and said slidably adjustable pill retaining means; and
a cutting blade fixedly attached to said lid which extends downward through said slot when the lid is in a closed position.

18. The pill cutting device of claim 17 wherein:
said attachment means are pivot points.

19. The pill cutting device of claim 17 wherein:
said attachment means is a hinge.

20. The pill cutting device of claim 17 wherein:
said attachment means is an axle.

21. The pill cutting device of claim 17 wherein:
said slidably adjustable pill retaining attaches to said base via a tenon which passes through said slot located in the base.

22. The pill cutting device of claim 17 wherein:
said slidably adjustable pill retaining device further comprises an adjustable wall and an adjustable base.

23. The pill cutting device of claim 22 wherein:
said slidable adjustable base further comprises finger grips.

24. The pill cutting device of claim 17 further comprising:
a pill storage are located in said base.

25. The pill cutting device of claim 17 further comprising:
finger grips located on said lid.
